(19) United States
(12) Patent Application Publication
(10) Pub. No.: US 2011/0120327 A1
(43) Pub. Date: May 26, 2011

(54) PRINTING APPARATUS AND PRINTING METHOD

(75) Inventor: Yoshimasa Araki, Yokohama-shi (JP)

(73) Assignee: CANON KABUSHIKI KAISHA, Tokyo (JP)

(21) Appl. No.: 12/949,417

(22) Filed: Nov. 18, 2010

(30) Foreign Application Priority Data
Nov. 26, 2009 (JP) 2009-269188

(51) Int. Cl. B41F 7/00

(52) U.S. Cl. 101/130

(57) ABSTRACT

A printing apparatus includes a plate forming member that forms a rewritable plate, a latent image forming unit, a projection forming unit configured to selectively adhere ink-repellent particles to a portion of a surface of the plate forming member where a latent image is formed in order to form a projection, a recording material supply unit, an intermediate transfer member for transfer of a recording material, a pressing unit configured to press the recording material on a surface of the intermediate transfer member during transfer of the recording material to a recording medium, and a conveying unit configured to convey the medium. The printing apparatus further includes a particle storage unit configured to store the particles, and a particle washing unit configured to wash at least part of the removed particles. At least part of the removed and washed particles is filled into the particle storage unit.

### BACKGROUND OF THE INVENTION

1. Field of the Invention

The present invention relates to an apparatus and a method for on-demand offset printing.

2. Description of the Related Art

Various types of so-called electrophotographic printers such as laser beam printers and LED (light emitting diode) printers have been proposed in the related art, and are widely used for the purpose of on-demand printing. Meanwhile, planographic offset printing has been used since a long time ago for the purpose of producing a large number (for example, 1000 or more) of printed materials of the same content by using a plate.

While modern electrophotographic printers provide a drastically improved image quality, they may not provide sufficient color uniformity (cause significant color differences) in printed materials, the entire surface of which is colored in a single color, or may curl printed materials. In addition, electrophotographic printers do not support printing on thin paper such as newsprint.

Meanwhile, the planographic offset printing has become the main method for newspaper printing, and has enabled to print in color on both surfaces of thin paper at a high speed. A major feature of the planographic offset printing is that the thickness of ink on printed materials is as thin as about 2 μm, which enables to provide printed materials with the feel and texture of the paper left intact.

However, the planographic offset printing requires much time and cost for plate making, and therefore incurs a high cost in the case where the number of prints to be output is small. Thus, the planographic offset printing is not widely used for purposes other than printing a large number of prints. In addition, a plate material once fabricated for offset printing cannot be diverted to other printing processes and must be disposed of after the intended printing.

In view of the above, there has been desired a new printing apparatus that is as convenient as electrophotographic printers but achieves an image quality comparable to the planographic offset printing on demand, and that does not take much time and cost even for a small number of prints to be output.

Japanese Patent Laid-Open No. 11-291603, for example, proposes an on-demand relief printing method that does not use “dampening water”. First, an image is formed on an ink-repellent surface of a plate cylinder using toner having an affinity for ink by an electrophotographic printing method, and heated for temporary fixation. Thereafter, ultraviolet-curable non-water offset printing ink is applied onto the toner, and the ink image is irradiated with ultraviolet light for curing to form a temporary “plate” that is firmer than the toner image alone. Non-water planographic printing ink is applied to the plate again, and transferred to a material to be printed (such as paper). After such manipulations for ink supply and transfer are repeated a predetermined number of times, the toner image temporarily fixed on the material with the ink-repellent surface is removed together with the ink image remaining on the toner image to enable on-demand printing.

Japanese Examined Utility Model Registration Application Publication No. 6-8603 discloses an electronic copying apparatus in which toner remaining on a photosensitive drum is recovered and foreign substances such as paper powder are removed using a filter to reuse the toner.

In the offset printing according to the related art, as discussed above, a plate material wound around a plate cylinder cannot be diverted to other printing processes and must be disposed of after the intended printing.

In the configuration disclosed in Japanese Patent Laid-Open No. 11-291603, toner forming a relief printing plate is not recovered and reused.

### SUMMARY OF THE INVENTION

The present invention is proposed in view of the foregoing circumstances, and provides an offset printing apparatus in which ink-repellent particles are adhered to a plate forming member to form a plate, and in which the ink-repellent particles are reused while preventing the ink-repellent particles from being deformed, damaged, or lost. The use of such an offset printing apparatus can prevent waste of the ink-repellent particles for the plate forming member, and reduce the printing cost.

The present invention provides a printing apparatus that uses a rewritable plate, including: a plate forming member; a latent image forming unit configured to write a latent image onto a surface of the plate forming member; a projection forming unit configured to selectively adhere ink-repellent particles to a portion of the surface of the plate forming member where the latent image is formed in order to form a projection; a recording material supply unit configured to supply a recording material to the surface of the plate forming member; an intermediate transfer member for transfer of the recording material supplied to the surface of the plate forming member; a pressing unit configured to press the recording material on a surface of the intermediate transfer member during transfer of the recording material to a recording medium; and a conveying unit configured to convey the recording medium, in which the printing apparatus further includes a particle storage unit configured to store the ink-repellent particles; a cleaner unit configured to remove the ink-repellent particles from the plate forming member; and a particle washing unit configured to wash at least part of the removed ink-repellent particles, and at least part of the ink-repellent particles removed from the plate forming member and then washed is filled into the particle storage unit.

The present invention also provides a printing method including: a latent image forming step of forming a latent image on a surface of a plate forming member that forms a rewritable plate; a projection forming step of selectively adhering ink-repellent particles to a portion of the surface of the plate forming member where the latent image is formed in order to form a projection; a recording material supply step of supplying a recording material to the surface of the plate forming member; a transfer step of transferring the recording material supplied to the surface of the plate forming member in the preceding step to an intermediate transfer member; a pressing step of pressing the recording material on a surface of the intermediate transfer member during transfer of the recording material to a recording medium; and a conveying step of conveying the recording medium to which the recording material has been transferred in the preceding step, in which the method further includes, subsequent to the transfer step, a cleaner step of removing the ink-repellent particles from the plate forming member; and a particle washing step of washing at least part of the ink-repellent particles removed in the preceding step, and at least part of the ink-repellent particles removed from the plate forming member and then washed is reused in the projection forming step.

According to the present invention, the ink-repellent particles adhering to the plate forming member are removed from the plate forming member by the cleaner unit, the removed ink-repellent particles are washed by the particle washing unit, and the washed ink-repellent particles are filled into the particle storage unit. Therefore, the ink-repellent particles are not disposed of but can be reused after transfer of ink to paper. As a result, the printing cost can be reduced. According to the present invention, in addition, the use of the ink-repellent particles eliminates the need for dampening water, which enables to provide an environmentally-friendly printing method.

Further features of the present invention will become apparent from the following description of exemplary embodiments with reference to the attached drawings.

### BRIEF DESCRIPTION OF THE DRAWINGS

FIG. 1 illustrates the configuration of a first embodiment of the present invention.

FIG. 2A illustrates an exposure/development process according to the first embodiment of the present invention.

FIG. 2B illustrates the exposure/development process according to the first embodiment of the present invention.

FIG. 2C illustrates the exposure/development process according to the first embodiment of the present invention.

FIG. 3A illustrates ink-repellent particles and ink on a surface of a photosensitive drum.

FIG. 3B illustrates transfer of the ink on the photosensitive drum to a blanket cylinder.

FIG. 4 illustrates the configuration of a second embodiment of the present invention.

### DESCRIPTION OF THE EMBODIMENTS

Embodiments of the present invention will be described below with reference to the drawings.

### First Embodiment

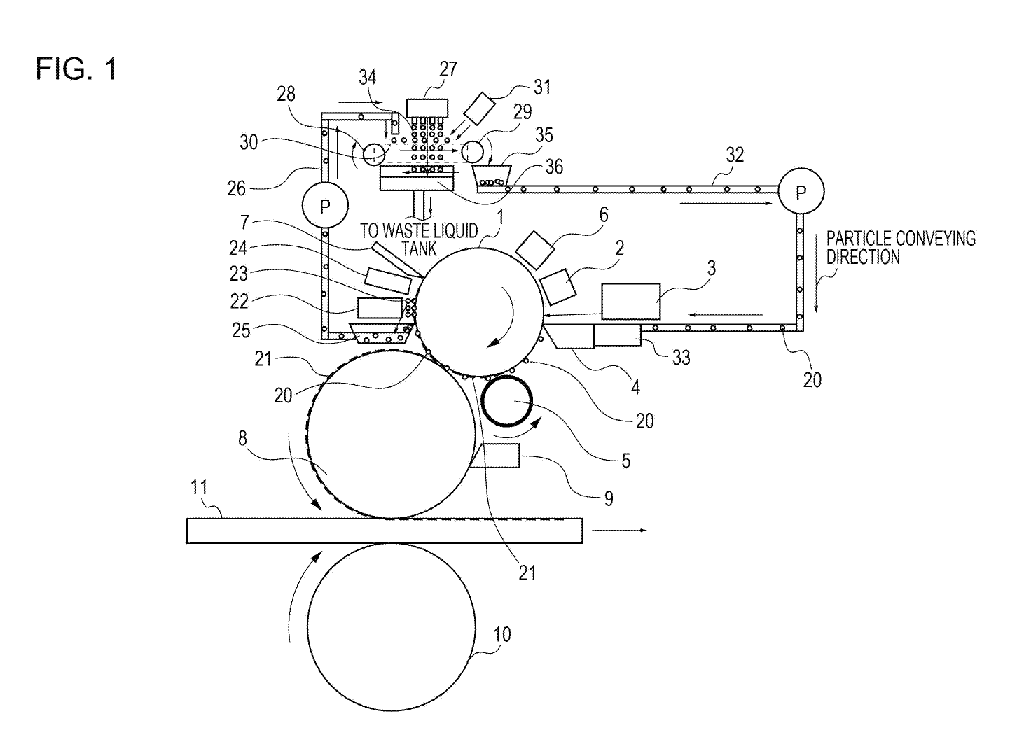

A first embodiment of the present invention will be described with reference to FIGS. 1, 2A to 2C, and 3A and 3B. As shown in FIG. 1, a printing apparatus according to the embodiment includes a photosensitive drum 1 serving as a plate forming member that forms a rewritable plate and made of an amorphous silicon photosensitive member (a-Si). A charger 2, an exposure unit 3, a developing unit 4, an ink roller 5, a charge eliminating unit 6, and a cleaner blade 7 are disposed around the photosensitive drum 1. The exposure unit 3 is formed as a latent image forming unit that writes a latent image onto a surface of the photosensitive drum 1 serving as a plate forming member. The developing unit 4 is formed as a projection forming unit that selectively adheres ink-repellent particles 20 to a portion of the surface of the photosensitive drum 1 serving as a plate forming member where the latent image is formed in order to form a projection. The ink roller 5 is formed as a recording material supply unit that supplies ink 21 serving as a recording material to the surface of the photosensitive drum (surface of a plate forming member). The printing apparatus further includes a blanket cylinder 8 serving as an intermediate transfer member for transfer of the ink 21 serving as a recording material supplied to the surface of the photosensitive drum 1 serving as a plate forming member. Further, a blanket cylinder cleaner 9 and an impression cylinder 10 are disposed around the blanket cylinder 8. The impression cylinder 10 serves as a pressing unit that presses the ink 21 serving as a recording material on a surface of the blanket cylinder 8 during transfer of the ink 21 to paper 11 serving as a recording medium. The blanket cylinder 8 and the impression cylinder 10 also serve as a conveying unit that conveys the paper 11 serving as a recording medium.

The photosensitive drum 1, the ink roller 5, the blanket cylinder 8, and the impression cylinder 10 are driven by a motor (not shown) to rotate in the direction of the respective arrows in FIG. 1 in correspondence with a digital signal (in which image portion data is mirror image data) sent from a host computer (not shown). In correspondence with this operation, the paper 11 serving as a recording medium is conveyed between the blanket cylinder 8 and the impression cylinder 10 by a conveying unit (not shown).

In the first embodiment, commercially available oil-based ink (sheet-fed offset printing ink Diatone Ecopure SOY-HPJ manufactured by SAKATA INX KABUSHIKI KAISHA) is used. As the photosensitive drum 1, an amorphous silicon photosensitive drum that can stably operate with ink containing a solvent is used. A surface (surface protective layer) of the amorphous silicon photosensitive drum 1 is formed by an amorphous material containing at least one of silicon and carbon as a base material, and has an affinity for ink (affinity for oil). The surface protective layer can be formed by a high-frequency plasma CVD (Chemical Vapor Deposition) method or a PCVD (Plasma Chemical Vapor Deposition) method.

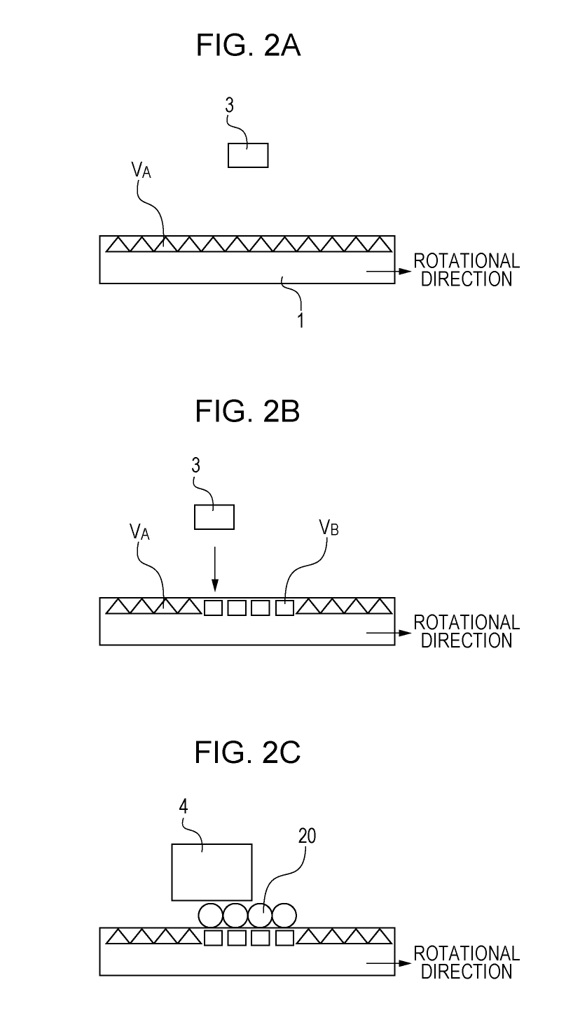

The surface of the photosensitive drum 1 is charged by the charger 2 to −600 V (potential V_{A} in FIG. 2A). Thereafter, an electrostatic latent image is written by the exposure unit 3 at a position corresponding to a non-image portion (potential V_{B} in FIG. 2B). In the embodiment, the potential V_{B} is about −30 V.

Next, the developing unit 4 storing the ink-repellent particles 20 negatively charged by friction is held at −400 V (potential V_{C}), and the ink-repellent particles 20 are adhered to the non-image portion (portion at −30 V) by reversal development (see FIG. 2C). The adhesion of the ink-repellent particles 20 is in principle based on the “relationship between an electric-field vector and a force vector”. An electric-field vector in the direction from the exposed surface to the developing unit 4 is formed between the developing unit at −400 V and the exposed surface at −30 V. Thus, at the same time, a force vector in the direction of attracting the ink-repellent particles 20 toward the non-image portion (portion at −30 V) acts on the ink-repellent particles 20 provided between the developing unit 4 and the non-image portion (portion at −30 V). On the other hand, an electric-field vector in the direction from the developing unit 4 to the unexposed surface at −600 V is formed between the unexposed surface at −600 V and the developing unit 4 at −400V. At the same time, a force vector acts in the direction of moving the ink-repellent particles 20 away from the unexposed surface at −600 V. This is the concept commonly used in the developing process of electrophotographic printing.

In the embodiment, the ink-repellent particles 20 are adhered by a so-called contact development method. The magnitude of the adhesion for the ink-repellent particles 20 may be adjusted under desired conditions by controlling the differences between the potentials V_{A}, V_{B}, and V_{C} with the absolute values of the potentials V_{A}, V_{B}, and V_{C} maintaining the relationship indicated by the formula 1 below in the case where the potentials V_{A}, V_{B}, and V_{C} are each a negative potential.

(Absolute value of potential V_{A})>(Absolute value of potential V_{C})>(Absolute value of potential V_{B}) [Formula 1]

In the case where the oil-based ink 21 is used, resins formed by hydrophilic polymers such as polyvinyl alcohol, polyvinyl pyrrolidone, polyacrylic acid, nylon, and cellulose may be used as the ink-repellent particles 20. In addition, hydrophobic and oil-repellent resins formed by fluorine, silicone, or the like may be used as the ink-repellent particles 20. Commercially available particles may also be used as the ink-repellent particles 20. Examples of such commercially available particles include polytetrafluoroethylene powder (Teflon (registered trademark) 7A) manufactured by DU PONT-MITSUI FLUOROCHEMICALS KABUSHIKI KAISHA, a polytetrafluoroethylene resin (PTFE) (Lubron (registered trademark) L-5F) manufactured by DAIKIN INDUSTRIES KABUSHIKI KAISHA, a tetrafluoroethylene/perfluoro (alkyl vinyl ether) copolymer (PFA) (MP10 (registered trademark)) manufactured by DU PONT-MITSUI FLUOROCHEMICALS KABUSHIKI KAISHA, and a tetrafluoroethylene hexafluoropropylene copolymer (FEP) (5328000 (registered trademark)) manufactured by DU PONT KABUSHIKI KAISHA. The ink-repellent particles 20 may be manufactured as follows. (1) A desired resin is melted and kneaded, and thereafter transformed into particles by pulverization, dispersion into a liquid, spraying into a gas, or the like. (2) A desired resin and a corresponding monomer are polymerized with each other and transformed into particles at the same time. Further, an oil and fat component, a magnetic material, a charge control agent, and so forth may be internally or externally added to the ink-repellent particles 20. Other additives that may be mixed with the ink-repellent particles 20 include inorganic fine powder, surface-treated inorganic fine powder, and organic fine powder. In the embodiment, polytetrafluoroethylene powder (Teflon (registered trademark) 7A) manufactured by DU PONT-MITSUI FLUOROCHEMICALS KABUSHIKI KAISHA added with 2 wt % of fine particles of silica is used as the ink-repellent particles 20.

In the case of offset printing, when the thickness of the ink 21 to be finally transferred to the paper 11 is 2 μm to 3 μm, an excellent image quality can be obtained. It is necessary that the ink 21 to be supplied to the surface of the photosensitive drum 1 serving as a plate forming member should have a thickness of larger than 2 μm to 3 μm. Thus, the average particle diameter of the ink-repellent particles 20 is preferably 5 μm to 170 μm, more preferably 5 μm to 20 μm, and further more preferably 5 μm to 10 μm.

The exposure unit 3 forms an electrostatic latent image on the photosensitive drum 1 by scanning with laser from a semiconductor laser oscillator through rotation of a polygonal mirror. The exposure unit 3 may use a light source formed by arranging LEDs (light emitting diodes).

Next, the ink 21 is supplied onto the photosensitive drum 1 by the ink roller 5. In this event, the ink roller 5 and the photosensitive drum 1 may be rotated with the difference in speed between the ink roller 5 and the photosensitive drum 1 in the circumferential direction at the position of contact between the ink roller 5 and the photosensitive drum 1 being substantially zero.

When the ink roller 5 and the photosensitive drum 1 are further rotated, a layer of the ink 21 adhering to the circumferential surface of the ink roller 5 is pressed against the photosensitive drum 1 to which the ink-repellent particles 20 are adhered. A surface of the layer of the ink 21 on the surface of the ink roller 5 and the ink-repellent particles 20 pressed against each other are subjected to a force for repelling each other due to the ink repellency (property to repel ink) of the ink-repellent particles 20. Thus, as the ink roller 5 and the photosensitive drum 1 are further rotated to widen the gap in the radial direction, the surface of the layer of the ink 21 and the ink-repellent particles 20 are separated by the ink repellency of the ink-repellent particles 20.

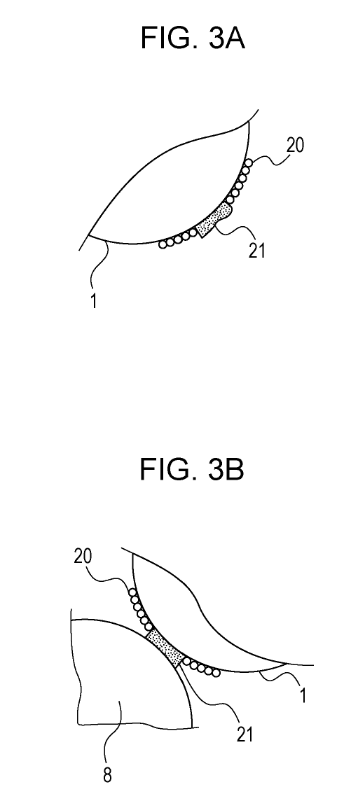

In contrast, the portion of the surface of the photosensitive drum 1 which has an affinity for ink (the region to which no ink-repellent particles 20 are adhered) is wetted with the ink 21 to adsorb the ink 21. Thus, as the ink roller 5 and the photosensitive drum 1 are further rotated to widen the gap in the radial direction, part of the layer of the ink 21 adhering to the circumferential surface of the ink roller 5 in the thickness direction is peeled off so that the ink 21 is retained on the surface of the photosensitive drum 1 (see FIG. 3A). This process is the same as in offset printing.

That is, in the embodiment, a surface of the ink-repellent particles 20 adhered to the portion of the surface of the photosensitive drum 1 serving as a plate forming member where the latent image is formed by the developing unit 4 serving as a projection forming unit has properties to repel the ink 21 serving as a recording material. Meanwhile, the surface of the photosensitive drum 1 has properties not to repel the ink 21. In the embodiment, in particular, the ink 21 serving as a recording material is oil-based ink, the surface of the ink-repellent particles 20 is oil-repellent, and the surface of the photosensitive drum 1 has an affinity for oil.

The thickness of the ink 21 to be retained on the surface of the photosensitive drum 1 is controlled by an adjustment method generally employed in offset printing, such as by adjusting the “amount of the gap between the ink roller 5 and the photosensitive drum 1” or the “thickness of the layer of the ink 21 on the surface of the ink roller 5”. While the ink-repellent particles 20 are illustrated as a single layer in FIG. 2C for convenience, the ink-repellent particles 20 may be formed in a plurality of layers as long as sufficient adhesion can act on the ink-repellent particles 20.

Thereafter, the ink 21 retained on the surface of the photosensitive drum 1 due to its wettability and the ink-repellent particles 20 retained on the same surface due to an electromagnetic image force move to the position of contact between the photosensitive drum 1 and the blanket cylinder 8. A rubber material having an affinity for ink is wound around a surface of the blanket cylinder 8 as in a blanket cylinder generally used for offset printing.

Only part of the layer of the ink 21 provided on the photosensitive drum 1 in the thickness direction undergoes an intermediate transfer to be transferred to the blanket cylinder 8 which is disposed with a desired gap (see FIG. 3B). In this event, the amount (thickness) of the layer of the ink 21 to be transferred is controlled by an adjustment method generally employed in offset printing, such as by adjusting the “amount of the gap between the photosensitive drum 1 and the blanket cylinder 8”. It is a matter of course that the amount of the layer of the ink 21 to be transferred is also relevant to adjusting the thickness of the ink 21 to be retained on the surface of the photosensitive drum 1, and that it may be necessary to adjust the “amount of the gap between the ink roller 5 and the photosensitive drum 1”, the “thickness of the layer of the ink 21 on the surface of the ink roller 5”, or the like.

In a final process, an image formed by the ink 21 transferred to the blanket cylinder 8 through the intermediate transfer is transferred to the paper 11 serving as a recording medium interposed between the blanket cylinder 8 and the impression cylinder 10 to complete printing. The blanket cylinder cleaner 9 removes the remaining ink from the region on the blanket cylinder 8 which has undergone the transfer to the paper 11 to restore the region to its initial state.

When printed materials of the same content are to be output, the operations of the cleaner blade 7, the charge eliminating unit 6, the charger 2, the exposure unit 3, and the developing unit 4 may be skipped after development is performed once using the ink-repellent particles 20 to enable high-speed printing.

After printing is performed on a required number of pieces of the paper 11, the ink-repellent particles 20 and the ink 21 on the photosensitive drum 1 are removed. For removal, a viscosity modifying agent 23 is first applied to the ink 21 on the photosensitive drum 1 from a viscosity modifying agent application section 22 serving as a viscosity adjusting unit for the ink 21. The viscosity modifying agent 23 may be an agent in which the ink 21 is easily soluble such as an ink diluent HS Solvent manufactured by GODO PRINTING INK MFG. KABUSHIKI KAISHA. The application of the viscosity modifying agent 23 reduces the viscosity of the ink 21 on the photosensitive drum 1, which makes it easy to remove the ink-repellent particles 20 and the ink 21 from the photosensitive drum 1. As a result, the ink-repellent particles 20 are not easily deformed or damaged when the cleaner blade 7 scrapes off the ink-repellent particles 20 and the ink 21 on the photosensitive drum 1.

Next, the ink 21 on the photosensitive drum 1 and the viscosity modifying agent 23 supplied from the viscosity modifying agent application section 22 are heated by a heater (not shown) provided in an ink heating section 24 serving as another viscosity adjusting unit. Such heating reduces the viscosity of the ink 21 on the photosensitive drum 1, which makes it easy to remove the ink-repellent particles 20 and the ink 21 from the photosensitive drum 1. As a result, the ink-repellent particles 20 are not easily deformed or damaged when the cleaner blade 7 scrapes off the ink-repellent particles 20, the ink 21, and the viscosity modifying agent 23 on the photosensitive drum 1. The heating temperature should be a temperature at which too much of the ink 21 and the viscosity modifying agent 23 applied from the viscosity modifying agent application section 22 is not evaporated and at which the ink-repellent particles 20 are not deformed, and may be about 30° C. to 40° C.

The ink-repellent particles 20 and the ink 21 removed from the photosensitive drum 1 by the cleaner blade 7 are recovered by a particle recovery section 25 together with the applied viscosity modifying agent 23. The ink-repellent particles 20, the ink 21, and the applied viscosity modifying agent 23 which have been recovered are supplied to a particle washing section 27 via a particle/ink conveying section 26 having a conveying pump.

In the particle washing section 27, the ink-repellent particles 20, the ink 21, and the applied viscosity modifying agent 23 are supplied onto a filter 30 wound around a roller A 28 and a roller B 29. As the roller A 28 and the roller B 29 are rotated clockwise by a drive system (not shown), the filter 30 moves in the direction of the arrow in the drawing. Holes formed in the filter 30 are smaller in diameter than the ink-repellent particles 20. The particle washing section 27 applies a washing liquid 34 to the ink-repellent particles 20, the ink 21, and the applied viscosity modifying agent 23 on the filter 30. The washing liquid 34 may be an agent in which the ink 21 is easily soluble such as an ink diluent HS Solvent manufactured by GODO PRINTING INK MFG. KABUSHIKI KAISHA, as with the viscosity modifying agent 23 applied from the viscosity modifying agent application section 22.

The application of the washing liquid 34 to the ink-repellent particles 20, the ink 21, and the applied viscosity modifying agent 23 washes away the ink 21 and the applied viscosity modifying agent 23 adhering to the ink-repellent particles 20, which pass through the filter 30 to be recovered by a waste liquid recovery section 36. The ink 21, the applied viscosity modifying agent 23, and the washing liquid 34 recovered by the waste liquid recovery section 36 are delivered from the waste liquid recovery section 36 to be recovered by a waste liquid tank (not shown).

A blower 31 sends air to the washed ink-repellent particles 20 to vaporize the washing liquid 34 adhering to the ink-repellent particles 20, as a result of which the washing liquid 34 is removed from the ink-repellent particles 20.

Thereafter, the roller A 28 and the roller B 29 are driven to move the filter 30 in the direction of the arrow in the drawing, as a result of which the ink-repellent particles 20 are recovered by a washed particle recovery section 35.

The ink-repellent particles 20 recovered by the washed particle recovery section 35 are conveyed to a particle storage section 33 via a particle conveying section 32 having a conveying pump. The conveying pump of the particle conveying section 32 may be a common screw-type powder conveying pump.

The ink-repellent particles 20 conveyed to the particle storage section 33 can be supplied to the developing unit 4 to be reused.

After the ink-repellent particles 20, the ink 21, and the applied viscosity modifying agent 23 are removed from the photosensitive drum 1, change on the photosensitive drum 1 is removed from the photosensitive drum 1 by the charge eliminating unit 6.

Thereafter, the operation of the charger 2, the operation of the exposure unit 3, and so forth are performed again to achieve on-demand digital offset printing.

While printing is performed using ink in a single color, for example black, for convenience in the above description, the configuration of FIG. 1 may be provided for each of inks 21 in cyan, magenta, and yellow colors to enable full-color printing.

To sum up, the printing method according to the embodiment uses a rewritable plate. The method includes a first step of writing a latent image onto a surface of the photosensitive drum 1 serving as a plate forming member that forms a rewritable plate, and a second step of adhering the ink-repellent particles 20 to a surface of the photosensitive drum 1 on the basis of the latent image to form a projection. The method further includes a third step of supplying the ink 21 serving as a recording material to the surface of the photosensitive drum 1 to form an image portion, and a fourth step of transferring the ink 21 on the surface of the photosensitive drum 1 to the blanket cylinder 8 serving as an intermediate transfer member. The method includes a step of providing the ink-repellent particles 20 with adhesion to the photosensitive drum 1 serving as a plate forming member during the third step. The method further includes a fifth step of transferring the ink 21 on a surface of the blanket cylinder 8 to the paper 11 serving as a recording medium.

A surface of the ink-repellent particles 20 has properties to repel the ink 21, and the surface of the photosensitive drum 1 has properties not to repel the ink 21.

The printing method further includes, subsequent to the fourth step, a cleaner step of removing the ink-repellent particles 20 from the surface of the photosensitive drum 1, and a particle washing step of washing at least part of the removed ink-repellent particles 20. In the printing method, at least part of the ink-repellent particles 20 removed from the photosensitive drum 1 and then washed is reused in the second step in which ink-repellent particles 20 are adhered to a portion of the surface of the photosensitive drum 1 in order to form a projection.

### Second Embodiment

In the first embodiment, the viscosity modifying agent 23 is applied from the viscosity modifying agent application section 22 to reduce the viscosity of the ink 21 adhering to the photosensitive drum 1. In addition, the ink 21 and the viscosity modifying agent 23 adhering to the photosensitive drum 1 are heated by the ink heating section 24 to reduce the viscosity of the ink 21 and the viscosity modifying agent 23.

In a second embodiment, meanwhile, a cleaner blade heater 39, a particle washing section heater 37, and a blower heater 38 are provided to mainly reduce the viscosity of the ink 21.

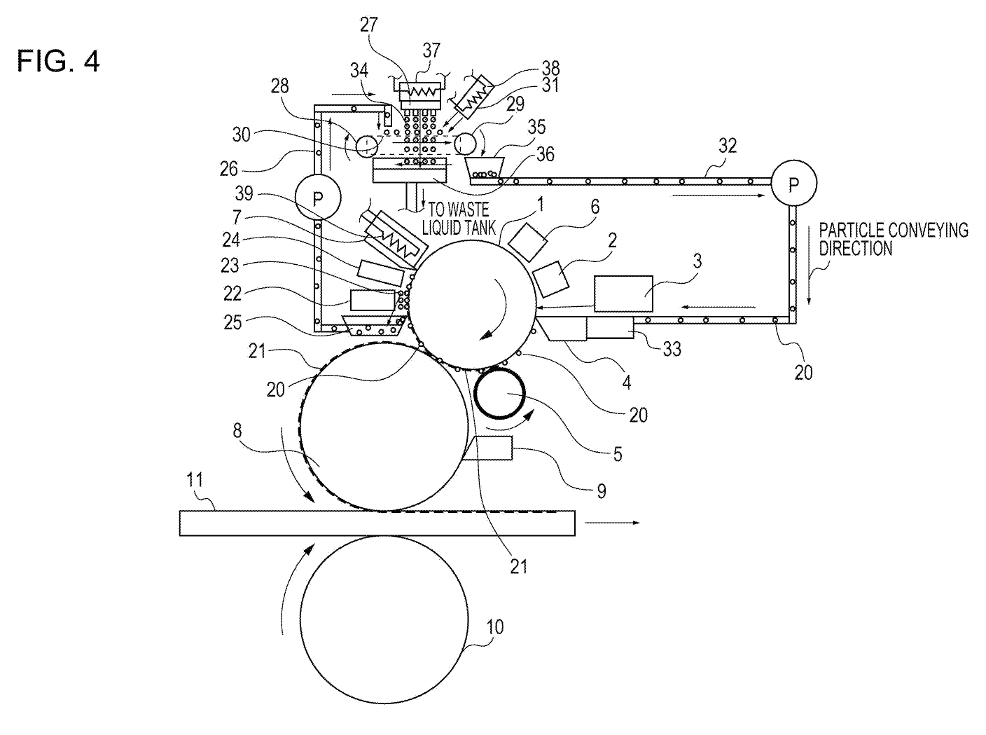

In the description below, components that are substantially identical to those of the first embodiment described with reference to FIGS. 1, 2A to 2C, and 3A and 3B are not described. A second embodiment of the present invention will be described with reference to FIG. 4.

In FIG. 4, the cleaner blade 7 is provided with the cleaner blade heater 39, which heats the cleaner blade 7 when the cleaner blade heater 39 is energized. Consequently, the ink 21 and the viscosity modifying agent 23 on the photosensitive drum 1 can be directly heated when the heated cleaner blade 7 scrapes off the ink 21 and the viscosity modifying agent 23, as a result of which the viscosity of the ink 21 and the viscosity modifying agent 23 can be reduced reliably. Reducing the viscosity makes it easy for the cleaner blade 7 to remove the ink 21 and the viscosity modifying agent 23. Moreover, the ink-repellent particles 20 are not easily deformed or damaged when the cleaner blade 7 scrapes off the ink-repellent particles 20, the ink 21, and the viscosity modifying agent 23 on the photosensitive drum 1. The heating temperature should be a temperature at which too much of the ink 21 and the viscosity modifying agent 23 is not evaporated and at which the ink-repellent particles 20 are not deformed, and may be about 30° C. to 40° C. A heater may be provided in the viscosity modifying agent application section 22 to heat the viscosity modifying agent 23. The heating temperature should be a temperature at which too much of the ink 21 and the viscosity modifying agent 23 is not evaporated and at which the ink-repellent particles 20 are not deformed, and may be about 30° C. to 40° C.

The particle washing section 27 is provided with the particle washing section heater 37, which heats the washing liquid 34 in the particle washing section 27 when the particle washing section heater 37 is energized. The heated washing liquid 34 heats the ink 21 adhering to the ink-repellent particles 20 to reduce its viscosity when the ink 21 is to be washed away. As a result, the ink 21 adhering to the ink-repellent particles 20 can be washed away easily, which enables reliable washing of the ink-repellent particles 20. The heating temperature should be a temperature at which too much of the ink 21 and the viscosity modifying agent 23 is not evaporated and at which the ink-repellent particles 20 are not deformed, and may be about 30° C. to 40° C.

The blower 31 is provided with the blower heater 38, which allows the blower 31 to send hot air when the blower heater 38 is energized. With the blower 31 sending hot air to the ink 21 adhering to the ink-repellent particles 20, the ink 21 is heated to reduce its viscosity. As a result, the ink 21 adhering to the ink-repellent particles 20 can be washed away easily, which enables reliable washing of the ink-repellent particles 20. The heating temperature should be a temperature at which too much of the ink 21 and the viscosity modifying agent 23 is not evaporated and at which the ink-repellent particles 20 are not deformed, and may be about 30° C. to 40° C.

The present invention is applicable to an apparatus and a method for on-demand offset printing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-269188 filed Nov. 26, 2009, which is hereby incorporated by reference herein in its entirety.

What is claimed is:

1. A printing apparatus that uses a rewritable plate, comprising:
a plate forming member that forms a rewritable plate;
a latent image forming unit configured to form a latent image on a surface of the plate forming member;
a projection forming unit configured to selectively adhere ink-repellent particles to a portion of the surface of the plate forming member where the latent image is formed in order to form a projection;
a recording material supply unit configured to supply a recording material to the surface of the plate forming member;
an intermediate transfer member for transfer of the recording material supplied to the surface of the plate forming member;
a pressing unit configured to press the recording material on a surface of the intermediate transfer member during transfer of the recording material to a recording medium; and
a conveying unit configured to convey the recording medium,
wherein the printing apparatus further includes
a particle storage unit configured to store the ink-repellent particles;
a cleaner unit configured to remove the ink-repellent particles from the plate forming member; and
a particle washing unit configured to wash at least part of the removed ink-repellent particles, and
at least part of the ink-repellent particles removed from the plate forming member and then washed is filled into the particle storage unit.

2. The printing apparatus according to claim 1, further comprising:
a viscosity adjusting unit configured to adjust a viscosity of the recording material adhering to the plate forming member.

3. The printing apparatus according to claim 2,
wherein the viscosity adjusting unit applies a liquid to the recording material adhering to the plate forming member.

4. The printing apparatus according to claim 2,
wherein the viscosity adjusting unit adjusts the viscosity by heating the recording material adhering to the plate forming member through a heating unit.

5. The printing apparatus according to claim 1,
wherein the cleaner unit is heated by a heating unit.

6. The printing apparatus according to claim 1,
wherein the particle washing unit includes a heating unit.

7. A printing method comprising:
a latent image forming step of forming a latent image on a surface of a plate forming member that forms a rewritable plate;
a projection forming step of selectively adhering ink-repellent particles to a portion of the surface of the plate forming member where the latent image is formed in order to form a projection;
a recording material supply step of supplying a recording material to the surface of the plate forming member;
a transfer step of transferring the recording material supplied to the surface of the plate forming member in the preceding step to an intermediate transfer member;
a pressing step of pressing the recording material on a surface of the intermediate transfer member during transfer of the recording material to a recording medium; and
a conveying step of conveying the recording medium to which the recording material has been transferred in the preceding step,
wherein the method further includes, subsequent to the transfer step,
a cleaner step of removing the ink-repellent particles from the plate forming member; and
a particle washing step of washing at least part of the ink-repellent particles removed in the preceding step, and
at least part of the ink-repellent particles removed from the plate forming member and then washed is reused in the projection forming step.

8. The printing method according to claim 7, further comprising:
a viscosity adjusting step of adjusting a viscosity of the recording material adhering to the plate forming member.

9. The printing method according to claim 8,
wherein the viscosity adjusting step includes a liquid application step of applying a liquid to the recording material adhering to the plate forming member.

10. The printing method according to claim 8,
wherein the viscosity adjusting step includes a step of adjusting the viscosity by heating the recording material adhering to the plate forming member through a heating unit.

11. The printing method according to claim 7,
wherein the cleaner step includes a step of heating a cleaner unit through a heating unit.

12. The printing method according to claim 7,
wherein the particle washing step includes a step of heating a particle washing unit.
